(19) United States
(12) Patent Application Publication
(10) Pub. No.: US 2026/0361383 A1
(43) Pub. Date: Nov. 12, 2026

(54) SENSING BEAM SELECTION FOR VEHICULAR SCENARIOS

(71) Applicant: Telefonaktiebolaget LM Ericsson (publ), Stockholm (SE)

(72) Inventors: Julia Equi, Espoo (FI); Gabor Fodor, Hässelby (SE); Ritesh Shreevastav, Upplands Väsby (SE)

(21) Appl. No.: 19/123,939

(22) PCT Filed: Dec. 15, 2023
(86) PCT No.: PCT/SE2023/051266

§ 371 Date: Apr. 24, 2025

Related U.S. Application Data
(60) Provisional application No. 63/432,729, filed on Dec. 15, 2022.

(51) Int. Cl. H04B 7/06

(52) U.S. Cl. CPC H04B 7/06958; H04B 7/0696

(57) ABSTRACT

Systems and methods are disclosed for sensing beam selection for vehicular scenarios. In one embodiment, a method performed by a network node for a wireless communication system comprises determining a geographic area of interest for sensing objects relevant to a moving vehicle equipped with a User Equipment (UE) based on a geographic location of the UE and a velocity vector of the UE and selecting a set of sensing beams for sensing objects relevant to the moving vehicle equipped with the UE based on the geographic area of interest and a beam direction of a beam used by the network node to transmit downlink information to the UE. The method further comprises performing a sensing procedure for passively sensing objects relevant to the moving vehicle using the set of sensing beams. In this manner, the geographical area that is sensed is limited, thereby reducing the time needed for passive sensing.

### RELATED APPLICATIONS

This application claims the benefit of provisional patent application Ser. No. 63/432,729, filed Dec. 15, 2022, the disclosure of which is hereby incorporated herein by reference in its entirety.

### TECHNICAL FIELD

The present disclosure relates to Integrated Sensing and Communications (ISAC) and, more specifically, to sensing beam selection.

### BACKGROUND

Using steerable antenna arrays for communications, sensing, and Integrated Sensing and Communications (ISAC) (also known as Joint Communications And Sensing (JCAS)) purposes has a long history, and several mechanisms for beam-steering, beamforming (BF), and multi-antenna reception have been proposed (see, e.g., C. Sturm and W. Wiesbeck, “Waveform Design and Signal Processing Aspects for Fusion of Wireless Communications and Radar Sensing”, Proceedings of the IEEE, Vol. 99, No. 7, July 2011.). It is widely agreed that an ISAC system has advantages over a separate design because an integrated system reuses the same hardware, spectrum, and waveforms, while information about the sensed environment can be used to assist beamforming for communication purposes. Recently, the system architectures (SA1) group of the 3^{rd} Generation Partnership Project (3GPP) has defined study items to identify use cases and architectural enhancements that will enable ISAC in cellular networks (see 3GPP S2-2106022 New SID: 5G Architecture Enhancements for Harmonized Communications and Sensing Services, August 2021.).

There is a large interest in devising sensing and radar mechanisms that detect unconnected (passive) objects, such as vulnerable road users or animals in the vicinity of roads or vehicles. The area of interest around a vehicle typically depends on the environment (urban, rural, etc.), the speed and direction of the vehicle, and other factors.

3GPP New Radio (NR) operates both in Frequency Range 1 (FR1) and the higher Frequency Range 2 (FR2), which is the frequency range from 24.45 Gigahertz (GHz) to 52.6 GHz. In high frequency bands such as FR2, the radio links are highly susceptible to rapid channel variations and suffer from severe path loss. To address these challenges, the base stations and the mobile terminals in the 5^{th} Generation (5G) system use highly directional antennas for beamforming to achieve sufficient link budget in a wide area network. Furthermore, it is expected that antenna elements are deployed in multiple panels, each one pointing towards a given direction in order to cover a different area.

Depending upon the possibility of generating and projecting a number of beams, three different beamforming architectures can be used. These architectures are as follows:
a) Analog beamforming: This approach shapes the beam through a single radio frequency (RF) chain for all the antenna elements. The processing is done in analog domain, and it is possible to transmit/receive a beam in only one direction at a time.
b) Hybrid beamforming: This approach requires a number of RF chains equivalent to the number of beams to be formed. An N RF chain hybrid beamformer can hence produce N beams and enables the transceiver to transmit/receive N analog beams in N simultaneous directions.
c) Digital beamforming: Unlike hybrid and analog beamforming architectures, digital beamforming technique requires a separate RF chain and data converters for each antenna element and allows processing of the received signals in the digital domain. Digital beamforming potentially allows transceivers to simultaneously direct beams in an infinite number of directions.

3GPP has also defined different antenna ports for transmitting different signals. Several signals can be transmitted from the same base station antenna from different antenna ports. These signals can have the same large-scale properties, for instance in terms of Doppler shift/spread, average delay spread, or average delay. These antenna ports are then said to be quasi co-located (QCL).

The network can then signal to the User Equipment (UE) that two antenna ports are QCL. the UE knows that two antenna ports are QCL with respect to a certain parameter, the UE can estimate that parameter based on one of the antenna ports and use that estimate when receiving from the other antenna port. For instance, if antenna ports A and B are QCL with respect to average delay, the UE can estimate the average delay from the signal received from antenna port (known as the source reference signal (RS)) and assume that the signal received from antenna port B (target RS) has the same average delay.

Information about what assumptions can be made regarding QCL is signaled to the UE from the network. In NR, four types of QCL relations between a transmitted source RS and transmitted target RS are defined:
Type A: {Doppler shift, Doppler spread, average delay, delay spread}
Type B: {Doppler shift, Doppler spread}
Type C: {Average delay, Doppler shift}
Type D: {Spatial Rx parameter}

QCL type D was introduced to facilitate beam management with analog beamforming and is known as spatial QCL.

In FR2, multiple RF beams may be used to transmit and receive signals at a NR base station (gNB) and a UE. For each downlink (DL) beam from a gNB, there is typically an associated best UE receive (Rx) beam for receiving signals from the DL beam. The DL beam and the associated UE Rx beam form a beam pair. The beam pair can be identified through a so-called beam management process in NR.

A DL beam is (typically) identified by an associated DL RS transmitted in the beam, either periodically, semi-persistently, or a-periodically. The DL RS for this purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of different DL-RSs in the reported best DL beam to let the UE evaluate candidate UE RX beams.

Although not explicitly stated in the NR specifications, beam management has been divided into three procedures, schematically illustrated in FIG. 1:
P-1: The purpose of the P-1 procedure is to find a coarse direction for the UE using wide gNB transmit (TX) beam covering the whole angular sector.
P-2: The purpose of the P-2 procedure is to refine the gNB TX beam by doing a new beam search around the coarse direction found in P-1.
P-3: Procedure P-3 is used for UE that has analogue beamforming to let them find a suitable UE RX beam.

P-1 is expected to utilize beams with rather large beamwidths and where the beam reference signals are transmitted periodically and are shared between all UEs of the cell. Typical reference signals to use for P-1 are periodic CSI-RS or SSB. The UE then reports a number of N best beams to the gNB and their corresponding Reference Signal Received Power (RSRP).

P-2 is expected to use aperiodic/or semi-persistent CSI-RS transmitted in narrow beams around the coarse direction found in P-1.

P-3 is expected to use aperiodic/or semi-persistent CSI-RSs repeatedly transmitted in one narrow gNB TX beam. One alternative way is to let the UE determine a suitable UE RX beam based on the periodic SSB transmission. Since each SSB consists of four Orthogonal Frequency Division Multiplexing (OFDM) symbols, a maximum of four UE RX beams can be evaluated during each SSB burst transmission, with one evaluation per symbol. One benefit with using SSB instead of CSI-RS is that no extra overhead of CSI-RS transmission is needed.

There currently exist certain challenge(s). The fundamental problem of BF design in ISAC systems is that communications and sensing have different purposes and requirements for BF. Typically, the goal of sensing is to collect information from a larger geographical area, while BF for communications aims to realize high Signal-to-Noise Ratio (SNR) and reduce interference at unintended receivers. Therefore, time-varying directional scanning beams are desirable for sensing, while sharp and stable beams are required for communications for UEs in connected mode. The problem with existing technologies is that these two contradicting requirements are not resolved in a satisfactory manner in which both sensing and communications requirements are met without using complex and time-consuming algorithms. A solution to these contradictory requirements is needed in order to make ISAC systems viable.

### SUMMARY

Systems and methods are disclosed for sensing beam selection for vehicular scenarios. In one embodiment, a method performed by a network node for a wireless communication system comprises determining a geographic area of interest for sensing objects relevant to a moving vehicle equipped with a User Equipment (UE) based on a geographic location of the UE and a velocity vector of the UE and selecting a set of sensing beams for sensing objects relevant to the moving vehicle equipped with the UE based on the geographic area of interest and a beam direction of a beam used by the network node to transmit downlink information to the UE. The method further comprises performing a sensing procedure for passively sensing objects relevant to the moving vehicle using the set of sensing beams. In this manner, the geographical area that is sensed is limited by taking advantage of information that is related to communications and a current position and velocity of the moving vehicle. By limiting the sensed area, the time needed to detect objects in the geographical area of interest is reduced as compared with the case when the entire service area needs to be scanned by directional scanning beams.

In one embodiment, the steps of determining, selecting, and performing are performed by the network node simultaneously with a separate procedure for determining the beam used by the network node to transmit downlink information to the UE. In one embodiment, the steps of determining, selecting, and performing are performed by the network node on a first frequency or frequency range and the separate procedure for determining the beam used by the network node to transmit downlink information to the UE is performed on a second frequency or frequency range that is different than the first frequency or frequency range.

In one embodiment, the beam direction of the beam used by the network node to transmit downlink information to the UE comprises an angle of departure of the beam used by the network node to transmit downlink information to the UE.

In one embodiment, the geographic area of interest for sensing objects relevant to the moving vehicle equipped with the UE is a geographic area that includes the geographic location of the UE and an geographic area ahead of the geographic location of the UE as determined by the velocity vector of the UE.

In one embodiment, the velocity vector of the UE comprises a speed of movement of the UE and a direction of movement of the UE, and a size of the geographic area of interest for sensing objects relevant to the moving vehicle equipped with the UE is based on the speed of movement of the UE.

In one embodiment, the set of sensing beams for sensing objects relevant to the moving vehicle equipped with the UE consists of one or more beams directed to the determined geographic area of interest for sensing objects relevant to the moving vehicle equipped with the UE.

In one embodiment, the set of sensing beams for sensing objects relevant to the moving vehicle equipped with the UE comprises the beam used by the network node to transmit downlink information to the UE.

In one embodiment, selecting the set of sensing beams comprises selecting the set of sensing beams such that the set of sensing beams consists of one or more beams that: (a) are directed to the determined geographic area of interest for sensing objects relevant to the moving vehicle equipped with the UE and (b) have a transmit power that is based on a transmit power of the beam used by the network node to transmit downlink information to the UE.

In one embodiment, the velocity vector of the UE comprises a speed of movement of the UE and a direction of movement of the UE, and selecting the set of sensing beams comprises selecting the set of sensing beams such that a beam granularity of the set of sensing beams is based on the speed of movement of the UE.

In one embodiment, the network node is a base station of a cellular communications system. In one embodiment, the downlink information is downlink information carried by a Physical Downlink Shared Channel (PDSCH) to the UE. In one embodiment, one or more Quasi Co-Located (QCL) parameters are defined for the beam used by the network node to transmit downlink information to the UE and the set of sensing beams. In one embodiment, one or more QCL parameters are defined for a positioning reference signal beam and the set of sensing beams. In one embodiment, a QCL parameter determined for the beam used by the network node to transmit downlink information to the UE is used by the network node to select one or more parameters for one or more sensing beams, from among the set of sensing beams, for which there is a QCL relationship. In one embodiment, the one or more parameters for the one or more sensing beams comprise any one or more of the following parameters: beam direction, transmit power, precoder matrix, codebook, beam granularity in space, beam granularity in time, and beam granularity in frequency.

Corresponding embodiments of a network node are also disclosed. In one embodiment, a network node for a wireless communication system is adapted to determine a geographic area of interest for sensing objects relevant to a moving vehicle equipped with a UE based on a geographic location of the UE and a velocity vector of the UE and select a set of sensing beams for sensing objects relevant to the moving vehicle equipped with the UE based on the geographic area of interest and a beam direction of a beam used by the network node to transmit downlink information to the UE. The network node is further adapted to perform a sensing procedure for passively sensing objects relevant to the moving vehicle using the set of sensing beams.

In one embodiment, a network node for a wireless communication system comprises processing circuitry configured to cause the network node to determine a geographic area of interest for sensing objects relevant to a moving vehicle equipped with a UE based on a geographic location of the UE and a velocity vector of the UE and select a set of sensing beams for sensing objects relevant to the moving vehicle equipped with the UE based on the geographic area of interest and a beam direction of a beam used by the network node to transmit downlink information to the UE. The processing circuitry is further configured to cause the network node to perform a sensing procedure for passively sensing objects relevant to the moving vehicle using the set of sensing beams.

In another embodiment, a method performed by a network node for a wireless communication system comprises performing a beam selection procedure for selection of a transmit beam to use for downlink communication to a UE, selecting a set of sensing beams for sensing objects relevant to the UE, transmitting sensing signals on the set of sensing beams, and adapting one or more beams used for the beam selection procedure for the transmit beam to use for downlink communication to the UE based on results of transmitting the sensing signals on the set of sensing beams.

In one embodiment, selecting the set of sensing beams comprises selecting the set of sensing beams based on a geographic area of interest for sensing, the geographic area of interest for sensing being based on a current geographic location of the UE and a velocity of the UE.

In one embodiment, the UE is a UE with which a moving vehicle is equipped.

In one embodiment, performing the beam selection procedure comprises transmitting a first set of beams, receiving feedback information from the UE for at least one of the first set of beams, transmitting a second set of beams in a direction of the at least one of the first set of beams wherein each beam in the second set of beams is narrower than each beam in the first set of beams, receiving feedback information from the UE for at least one of the second set of beams, and selecting a transmit beam to use for downlink communication with the UE based on the feedback information from the UE for the at least one of the second set of beams. In one embodiment, the first set of beams is a set of communication beams. In one embodiment, the set of communication beams is a set of Synchronization Signal (SS) and Physical Broadcast Channel (PBCH) block (SSB) and/or Channel State Information Reference Signal (CSI-RS) beams. In one embodiment, the second set of beams is a set of positioning beams. In one embodiment, the set of positioning beams is a set of Positioning Reference Signal (PRS) beams. In one embodiment, adapting one or more beams used for the beam selection procedure comprises adapting one or more of the first set of beams and/or one or more of the second set of beams, based on results of transmitting the sensing signals on the set of sensing beams.

In one embodiment, the results of the transmitting the sensing signals on the set of sensing beams comprises a determination that an object is sensed for one of the set of sensing beams, and adapting one or more beams used for the beam selection procedure comprises adapting one or more parameters for one or more beams used for the beam selection procedure based on the one of the set of sensing beams for which an object is sensed. In one embodiment, adapting the one or more parameters for the one or more beams used for the beam selection procedure comprises adapting the one or more parameters for the one or more beams used for the beam selection procedure based on a QCL relationship defined between the one of the set of sensing beams and one or more of the first and/or second set(s) of beams. In one embodiment, the one or more parameters that are adapted comprise one or more spatial transmit parameters.

In one embodiment, the results of the transmitting the sensing signals on the set of sensing beams comprises a determination that an object is sensed for one of the set of sensing beams, and adapting the one or more parameters comprises adapting either or both of: one or more angular offsets for the one or more beams used for the beam selection procedure relative to the one of the set of sensing beams for which the object is detected and a transmission reference point used for transmitting the sensing beams.

Corresponding embodiments of a network node are also disclosed. In one embodiment, a network node for a wireless communication system is adapted to perform a beam selection procedure for selection of a transmit beam to use for downlink communication to a UE, select a set of sensing beams for sensing objects relevant to the UE, transmit sensing signals on the set of sensing beams, and adapt one or more beams used for the beam selection procedure for the transmit beam to use for downlink communication to the UE based on results of transmitting the sensing signals on the set of sensing beams.

In one embodiment, a network node for a wireless communication system comprises processing circuitry configured to cause the network node to perform a beam selection procedure for selection of a transmit beam to use for downlink communication to a UE, select a set of sensing beams for sensing objects relevant to the UE, transmit sensing signals on the set of sensing beams, and adapt one or more beams used for the beam selection procedure for the transmit beam to use for downlink communication to the UE based on results of transmitting the sensing signals on the set of sensing beams.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a beam management procedure used for a New Radio (NR) network;

FIG. 2 illustrates one example of a cellular communications system in which embodiments of the present disclosure may be implemented;

FIG. 3 illustrates a system that implements a procedure for sensing beam selection based on wide communication beams, narrow positioning beam, and an area (referred to herein as an “area of interest” for sensing) ahead of a moving vehicle equipped with a User Equipment (UE), in accordance with one example embodiment of the present disclosure;

FIG. 4 is a flow chart that illustrates a procedure performed by a network node (e.g., the base station of FIG. 3) for selecting and using a set of sensing beams, in accordance with one embodiment of the present disclosure;

FIG. 5A is a flow chart that illustrates a procedure performed by a network node (e.g., the base station of FIG. 3), in accordance with another embodiment of the present disclosure

FIG. 5B is a flow chart that illustrates a beam selection for selection of a transmit beam to use for downlink communication to the UE, in accordance with one embodiment of the present disclosure;

FIGS. 6, 7, and 8 are schematic block diagrams of example embodiments of a network node;

FIGS. 9 and 10 are schematic block diagrams of example embodiments of a wireless communication device (e.g., a UE);

FIG. 11 illustrates an example embodiment of a communication system in which embodiments of the present disclosure may be implemented;

FIG. 12 illustrates example implementations of the host computer, base station, and UE of FIG. 11; and

FIGS. 13, 14, 15, and 16 are flow charts that illustrate example embodiments of methods that may be performed in the communication system of FIG. 11.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Certain aspects of the present disclosure and their embodiments may provide solutions to the aforementioned or other challenges. Systems and methods are disclosed herein for sensing beam selection, e.g., for a Integrated Sensing and Communications (ISAC) system. In one embodiment, the systems and methods disclosed herein are applicable to vehicular scenarios.

In one embodiment, a method performed by a network node (e.g., a base station) for sensing beam selection includes identifying an area of interest for sensing using a current position and velocity vector of a vehicle equipped with a UE, thereby creating an a-priori knowledge for forming directional scanning beams for sensing. The method performed by the network node further includes determining a set of scanning beams for sensing based on the following information:
1) The identified or determined area of interest (e.g., area ahead of the vehicle equipped with the UE) according to the velocity vector of the vehicle equipped with the UE (i.e., the speed and direction of movement of the vehicle equipped with the UE).
2) A beam direction, including angle of departure (AoD), of a beam used for transmitting downlink (DL) information (e.g., a beam used for transmitting Physical Downlink Shared Channel (PDSCH)) to the UE of the vehicle. In one embodiment, this beam direction of the beam used for transmitting DL information to the UE of the vehicle is determined using Channel State Information (CSI) at the transmitter (CSIT) or feedback information by the UE (vehicle) that helps determine the beamforming (BF) vector out of a codebook.

In one embodiment, the method performed by the network node further includes performing a sensing procedure using the determined set of scanning beams for sensing.

In one embodiment, CSIT-based beamforming as well as vehicular velocity vector-based vehicle position estimation are used to determine the area that should be sensed and the set of beams for sensing the area around and ahead of a vehicle. In this manner, the scanning beams are focused into an area that is the most important for object and vulnerable road user (VRU) detection close to and ahead of a moving vehicle.

In one embodiment, communication and positioning-assisted sensing beam forming are provided. In return, communication and positioning transmission (beamforming, beam directivity etc.) are further optimized for ISAC.

Certain embodiments may provide one or more of the following technical advantage(s). Embodiments of the present disclosure limit the geographical area that is sensed by taking advantage of information that is related to communications and a current position and velocity of a moving vehicle. By limiting the sensed area, the time needed to detect objects in the geographical area of interest is reduced as compared with the case when the entire service area needs to be scanned by directional scanning beams.

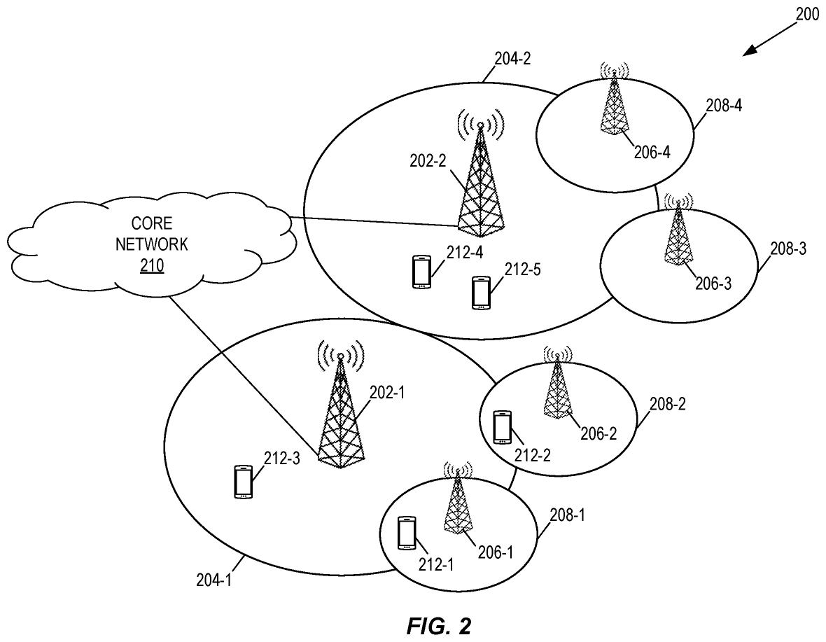

FIG. 2 illustrates one example of a cellular communications system 200 in which embodiments of the present disclosure may be implemented. In the embodiments described herein, the cellular communications system 200 is a 5G System (5GS) including a Next Generation RAN (NG-RAN) and a 5G Core (5GC); however, the present disclosure is not limited to a 5GS and may be used in any type of wireless communication system (e.g., 6G) in which beamforming is used. In this example, the RAN includes base stations 202-1 and 202-2, [which in the 5GS include gNBs and optionally next generation eNBs (ng-eNBs) (e.g., LTE RAN nodes connected to the 5GC), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs and as such sometimes referred to herein as UEs 212, but the present disclosure is not limited thereto.

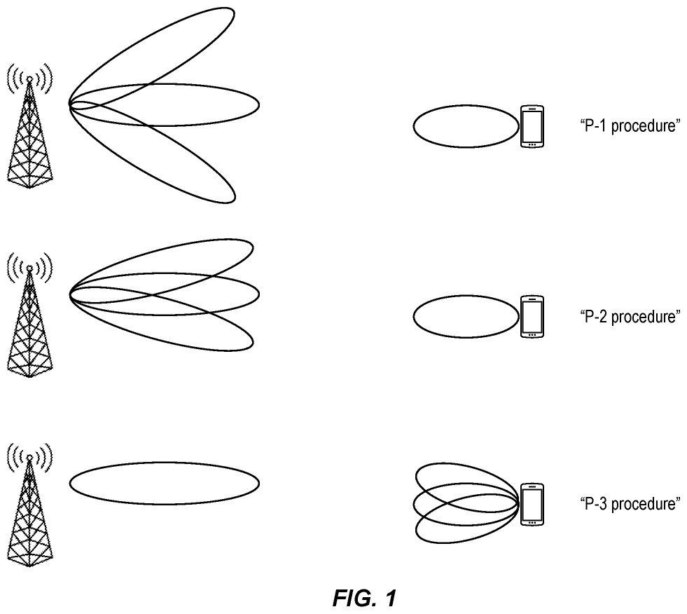

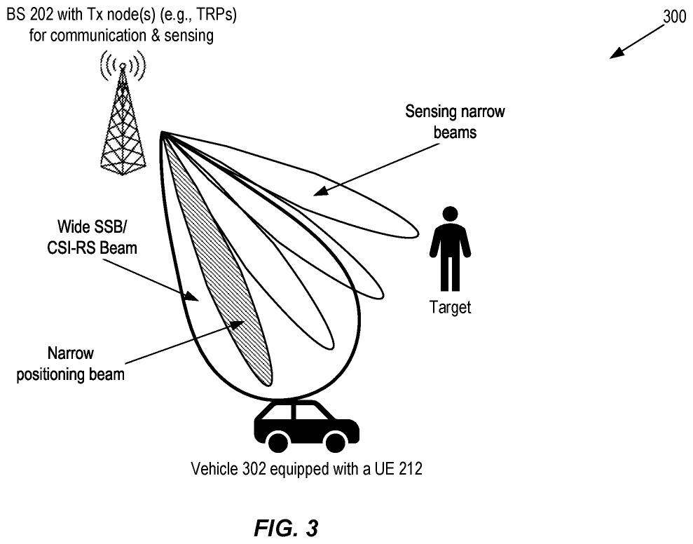

FIG. 3 illustrates a system 300 that implements a procedure for sensing beam selection based on wide communication beams, narrow positioning beam, and an area (referred to herein as an “area of interest” for sensing) ahead of a moving vehicle 302 equipped with a UE 212 in accordance with one example embodiment of the present disclosure. As illustrated, the system 300 includes the moving vehicle equipped with the UE 212 and a base station 202 that includes one or more transmit nodes (e.g., one or more TRPs) for ISAC. As discussed below, the base station 202 performs beam selection for communication with (e.g., downlink communication with) the UE 212 with which the moving vehicle 302 is equipped. The beam selection for communication with the UE 212 is performed, in the illustrated example, using wide communication beams and narrow positioning beams. In the illustrated example, the wide communication beam is a wide Synchronization Signal (SS) and Physical Broadcast Channel (PBCH) Block (SSB) or Channel State Information Reference Signal (CSI-RS) beam (i.e., a transmit beam on which SSB and/or CSI-RS is transmitted, e.g., in procedure P-1 of FIG. 1), and the narrow positioning beams are Positioning Reference Signal (PRS) beams (i.e., transmit beams on which PRS is transmitted, e.g., in procedure P-2 of FIG. 1). As described below, the base station 202 also selects a set of beams for sensing (i.e., a set of sensing beams). The transmit beams in the selected set of beams for sensing are utilized for a passive sensing procedure in which the base station 202 (or the transmit node(s) of the base station 202) transmit sensing signals on the sensing beams and monitor for signals passively reflected by passive objects (e.g., humans, buildings, other moving vehicles, etc.).

In accordance with embodiments of the present disclosure, the base station 202 determines the area of interest for sensing using a current position and velocity vector of the moving vehicle 302 equipped with the UE 212 and thereby creates an a-priori knowledge for forming directional scanning beams for sensing. The base station 202 identifies or determines the set of scanning beams for sensing based on either or both of the following information:
1) The determined area of interest for sensing (i.e., an area ahead of the moving vehicle 302 equipped with the UE 212 according to a current position and velocity (i.e., speed and direction) of movement of the moving vehicle 302 (or equivalently the current position and velocity of movement of the UE 212 with which the moving vehicle 302 is equipped).
2) A beam direction, including angle of departure (AoD), of a beam used for transmitting downlink (DL) information (e.g., PDSCH) to the moving vehicle 302 (or more specifically to the UE 212 with which the moving vehicle 302 is equipped). The beam direction of this beam may be determined using, e.g., CSI at the transmitter (CSIT) (e.g., CSI at the base station 202 or respective transmit node (e.g., TRP) of the base station 202) or feedback information from the UE 212 (vehicle) that helps determine the beamforming vector out of a codebook.

Selection and transmission of the set of beams for sensing and selection and transmission of the beam for communication (e.g., downlink transmission) are performed by the base station 202 in two stages. In the first stage, the base station 202 uses known mechanisms to obtain CSIT to select and transmit a DL beam for communications purposes (e.g., a DL beam for PDSCH transmission) towards the UE 212 at the moving vehicle 302. In the second stage, a set of time-varying directional scanning beams are selected and transmitted by the base station 202 to scan the determined area of interest (e.g., around and ahead of the moving vehicle 302, e.g., mainly in the direction in which the vehicle 302 is moving). During this second stage, the base station 202 uses a specific set of its antenna array for active sensing based on backscattered signals.

The two stages above (Stage 1: selection of a beam for communication and transmission on the selected beam for communication; Stage 2: selection of the set of beams for sensing in a limited geographic area around the moving vehicle 302 and transmission on the selected sensing beams) can be executed simultaneously in time, e.g., at different frequencies or in different frequency ranges. In one embodiment, the communication beam is associated with a set of beams used for simultaneously sensing the surrounding area while transmitting the DL beam used for communications purposes (e.g., the DL beam associated with PDSCH).

In one embodiment, quasi-collocated (QCL) properties are defined among communication, positioning, and sensing beams.

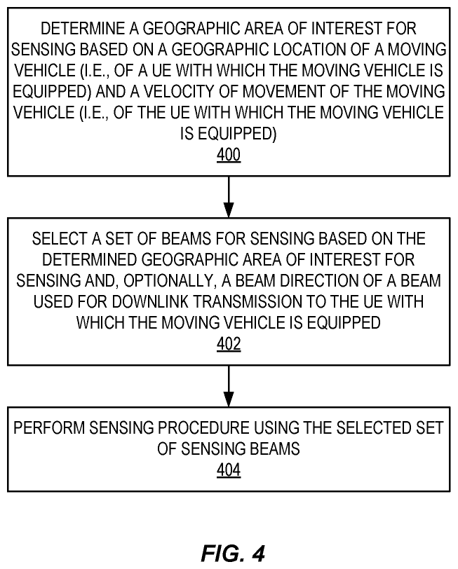

FIG. 4 is a flow chart that illustrates a procedure performed by a network node (e.g., the base station 202 of FIG. 3) for selecting and using a set of sensing beams in accordance with one embodiment of the present disclosure. As illustrated, the network node determines a geographic area of interest for sensing objects near (i.e., relevant to) the moving vehicle 302 equipped with the UE 212 (step 400). The network node determines the geographic area of interest for sensing objects near the moving vehicle 302 based on a (e.g., current) geographic location of the UE 212 with which the moving vehicle 302 is equipped (which is equivalent to the location of the moving vehicle 302) and a velocity (i.e., speed and direction) of movement of the UE 212 (and thus the moving vehicle 302). For example, the geographic area of interest may be a geographic area that includes the current location of the UE 212 and extends ahead of the moving vehicle 302 considering the direction of movement of the UE 212. Further, a size of the geographic area of interest may be based on (e.g., a function of) the speed of movement of the UE 212. For example, considering two speeds (S1 and S2) where S1>S2, the size of the geographic area of interest may be larger for S2 than for S1. Thus, in other words, the size of the geographic area of interest may increase as speed increases.

The network node selects a set of beams (i.e., a set of sensing beams) for sensing objects near the moving vehicle 302 based on the determined geographic area of interest for sensing (step 402). In one embodiment, the network node selects the set of sensing beams based on both the determined geographic area of interest for sensing and a beam direction (e.g., including an AoD) of a beam used for communication (e.g., used for downlink transmission of information such as, e.g., transmission of PDSCH) to the UE 212 with which the moving vehicle 302 is equipped. For example, the network node may select a subset of a set of candidate sensing beams such that the selected subset includes, or alternatively consists only of, those candidate sensing beams that are known to be directed to the determined geographic area of interest for sensing. In one embodiment, the selected set of sensing beams includes the beam used for communication to the UE 212 with which the moving vehicle 302 is equipped. In one embodiment, the network node selects the set of scanning beams such that the selected set of scanning beams are directed to the determined geographic area of interest for sensing and have a transmit power that is based on (e.g., corresponds to) the transmit power of the transmit beam used for communication (e.g., downlink transmission) to the UE 212 at the moving vehicle 302. In another embodiment, the set of scanning beams is chosen based on some information about the UE 212, known and/or detected at and/or by the network or sent by the UE 212 (e.g., speed, direction). For example, higher beam granularity (more beams per radial interval or higher beam periodicity in time) may be used for high speed UEs as compared to low speed UEs.

The network node performs a sensing procedure using the selected set of sensing beams (step 404). For example, in one embodiment, the network node transmits a signal (e.g., a predefined or known signal) on each of the selected set of sensing beams and monitors for a reflected (e.g., backscattered) signal. Using the reflected signals resulting from the transmissions on the sensing beams, the network node is able to determine whether any objects are present in near the moving vehicle 302 (e.g., in the determined geographic area of interest for sensing) and take an appropriate action(s) (e.g., notify the moving vehicle 302 of detected object(s)).

In one embodiment, the procedure of FIG. 4 is performed by the network node simultaneously with a separate procedure for selecting the transmit beam for communication (e.g., downlink transmission) to the UE 212 at the moving vehicle 302. In one embodiment, these two procedures may use different frequencies or frequency ranges.

In one embodiment, one or more QCL parameters may be defined for the communication beam, the PRS beams, and the sensing beams. Thus, for example, a QCL parameter determined for the communication beam or a PRS beam based on respective feedback from the UE 212 may be used by the network node (e.g., base station 202) to select one or more parameters (e.g., beam direction, transmit power, precoder matrix, codebook, beam granularity in space (e.g., number of beams per radial interval), in time (e.g., periodicity of a given beam at a given beam direction), or in frequency) for the sensing beam(s) for which there is a QCL relationship. Importantly, this QCL aspect may be used regardless of how the set of sensing beams is selected (i.e., the selection scheme for selecting the set of sensing beams described above with respect to FIG. 4 is only an example).

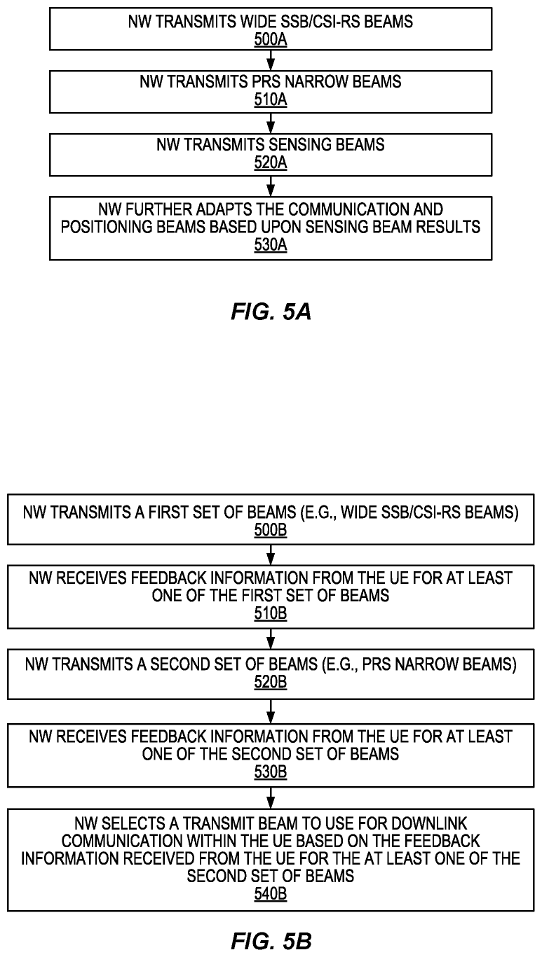

FIG. 5A is a flow chart that illustrates a procedure performed by a network node (e.g., the base station 202 of FIG. 3) in accordance with another embodiment of the present disclosure. Note that the procedure of FIG. 5A is not limited to the use of the selection scheme for selecting the set of sensing beams described above; however, the selection scheme for selecting the set of sensing beams described above may be used in the procedure of FIG. 5A. The steps of the procedure of FIG. 5A are described below.

Step 500A: The network node transmits one or more wide beams in the downlink. Each wide beam is, in this example, a transmit beam in which SSB and/or CSI-RS is transmitted and, as such, the wide beam is sometimes referred to herein as a wide SSB/CSI-RS beam. Then, based upon feedback (SSB/CSI-RS RSRP measurements) received from a UE (e.g., the UE 212 at the moving vehicle 302) for at least one of the SSB/CSI-RS beams, the network node performs step 510A.

Step 510A: The network node transmits narrow PRS beams towards one or more of the SSB/CSI-RS beams (e.g., in directions within and possibly around the wide TX beam used for transmission of the one or more SSB/CSI-RS beams). The one or more SSB/CSI-RS beams towards which the PRS beams are transmitted are, e.g., one or more of the SSB/CSI-RS beams for which the respective SSB/CSI-RS RSRP measurement values are greater than a predefined or configured threshold or the M strongest SSB/CSI-RS beams as determined by the received RSRP measurement values (where M is a predefined or configured value that is greater than or equal to 1 but less than all of the total number of SSB/CSI-RS beams transmitted in step 500A). The UE provides (and the network node receives) feedback about the PRS beams, which can be in terms of classification of Line-of-Sight (LOS)/Non-LOS (NLOS) paths or information from which the network node deduces from the multipath analysis the LOS/NLOS path. The network node performs step 520A based on this feedback.

Step 520A: The network node transmits sensing beams towards the NLOS path to sense the environment and understand what causes NLOS and to further categorize or understand if there is any hazard (traffic accident risk etc. or to perform any sensing related use cases). Note that, in one embodiment, the sensing beams used may be selected based on a determined geographic area of interest for sensing as described above. Also note that the sensing results, which may also be referred to herein as “results of transmitting the sensing beams” or “results of the sensing procedure”, include information that assists the network in understanding what causes NLOS and to further categorize or understand if there is any hazard. Such information may include, for example, information that indicates detection of one or more passive objects, information that indicates the position (e.g., relative position) of the detected passive object(s) (e.g., angle, distance), and/or information that indicates a velocity of movement of the detected passive object(s).

Step 530A: The sensing beam results further provide feedback to the network node to understand how beam forming for communication and positioning can be performed/optimized. For example, identifying more LOS path beams for communication and positioning.

### Other Embodiments

In some embodiments, only a subset of steps 500A, 510A, 520A, 530A is performed. The order of the different steps can be different.

In some embodiments, the communication, positioning, and sensing beams are formed following one of the beam management procedures such as the ones described in FIG. 1 (for example, P-1, P-2, P-3).

### Step 520A: NW Transmits Sensing Beams

In another embodiment, sensing beams are switched according to a beam sweeping procedure.

In some embodiments, the sensing beams are sent within a sensing area which can be a fixed geographical area, such an intersection in an urban scenario.

In another embodiment, the sensing area is moving with the UE(s) of interest based on the UE's speed/direction (e.g., as described above).

In one embodiment, sensing beams are defined as a function of the sensing area and eventually additional information on the movement of other UE(s) entering/exiting the area of sensing interest.

In some other embodiments, the sensing area is defined according to the sidelink control information (SCI) when the UE/UEs is/are involved in sidelink communication with other UE(s).

Step 530A: Further adapt the communication beam and/or positioning beam based upon sensing beam results.

In one embodiment, sensing beams are adapted based on one of the embodiments from Step 520A.

### QCL Relation in Terms of Sensing

In one embodiment, a new QCL Relation for QCL relations between a transmitted source RS for sensing and a transmitted target RS for either communication or positioning is defined as below in terms of sensing. Further similar can be defined vice-versa; i.e., Source RS can be communication or positioning and target RS can be sensing beams.
Type X: {Sensing Rx parameter, Sensing Spatial Rx Parameter}
Type Y: {Sensing Tx parameter, Sensing Spatial Rx Parameter}
Type Z: {Positioning Tx parameter, Positioning Spatial Rx Parameter}
Type XX: {Communication Tx parameter, Communication Spatial Rx Parameter}
Type YY: {Doppler shift, Doppler spread, average delay, delay spread}

In one embodiment, the results of transmitting the sensing signals on the set of sensing beams (in step 520A) comprises a determination that an object is sensed for one of the set of sensing beams, and adapting (in step 530A) one or more beams used for the beam selection procedure comprises adapting one or more parameters for one or more beams used for the beam selection procedure based on the one of the set of sensing beams for which an object is sensed (e.g., based on defined QCL relation(s)). For example, in one embodiment, the network node (e.g., base station 202) configures the positioning beam based upon the sensing results. For example, the network node (e.g., base station 202) may configure the positioning beams with the same spatial Tx parameters (such as, e.g., precoder matrix, weights, codebook for beam forming, same Tx Power, etc.) as that of the sensing beam (Tx or Rx) for which the network node identified, or detected, an object (e.g., based on which sensing beam identified the object). Alternatively, an angular offset is provided such that positioning beams are transmitted with an offset to sensing beams. Further, a reference transmission reception point (TRP) resource set which is transmitting Positioning Reference Signal (PRS) resources (beams) can be defined as a reference for transmitting sensing beam or signal to be used for sensing purpose.

In FIG. 5A, steps 500A and 510A represent a beam selection procedure for selection of a transmit beam to use for downlink communication to the UE 212. FIG. 5B is a flow chart that illustrates a beam selection for selection of a transmit beam to use for downlink communication to the UE 212, in accordance with one embodiment of the present disclosure. This procedure may be viewed as one example embodiment of the beam selection procedure represented by steps 500A and 510A of FIG. 5A. The steps of the procedure of FIG. 5B are described below.

Step 500B: The network node 202 transmits a first set of beams (e.g., wide SSB and/or CSI-RS beams).

Step 510B: The network node 202 receives feedback information (e.g., RSRP or similar measurement value) from the UE 212 for at least one of the first set of beams.

Step 520B: The network node 202 transmits a second set of beams (e.g., PRS narrow beams) in a direction of the at least one of the first set of beams, wherein each beam in the second set of beams is narrower than each of the beams in the first set of beams.

Step 530B: The network node 202 receives feedback information (e.g., RSRP or similar measurement value) from the UE 212 for at least one of the second set of beams.

Step 540B: The network node 202 selects a transmit beam to use for downlink communication with the UE 212 based on the feedback information received from the UE 212 for the at least one of the second set of beams.

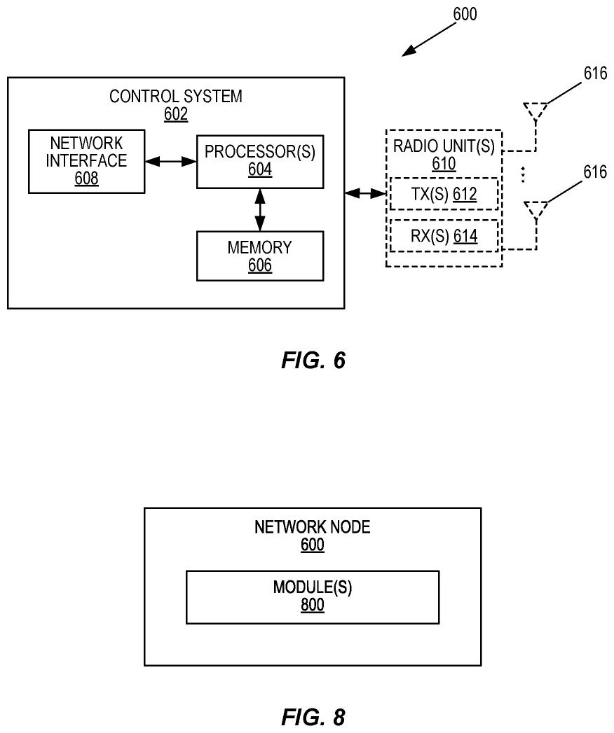

FIG. 6 is a schematic block diagram of a network node 600 according to some embodiments of the present disclosure. Optional features are represented by dashed boxes. The network node 600 may be, for example, a base station 202 or a network node that implements all or part of the functionality of the base station 202 described herein. As illustrated, the network node 600 includes a control system 602 that includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. In addition, if the network node 600 is a radio access node (e.g., a base station 202, gNB, or network node that implements at least some of the functionality of the base station 202 or gNB), the network node 600 may include one or more radio units 610 that each includes one or more transmitters 612 and one or more receivers 614 coupled to one or more antennas 616. The radio units 610 may be referred to or be part of radio interface circuitry. In some embodiments, the radio unit(s) 610 is external to the control system 602 and connected to the control system 602 via, e.g., a wired connection (e.g., an optical cable). However, in some other embodiments, the radio unit(s) 610 and potentially the antenna(s) 616 are integrated together with the control system 602. The one or more processors 604 operate to provide one or more functions of the network node 600 as described herein (e.g., one or more functions of a base station 202 described herein). In some embodiments, the function(s) are implemented in software that is stored, e.g., in the memory 606 and executed by the one or more processors 604.

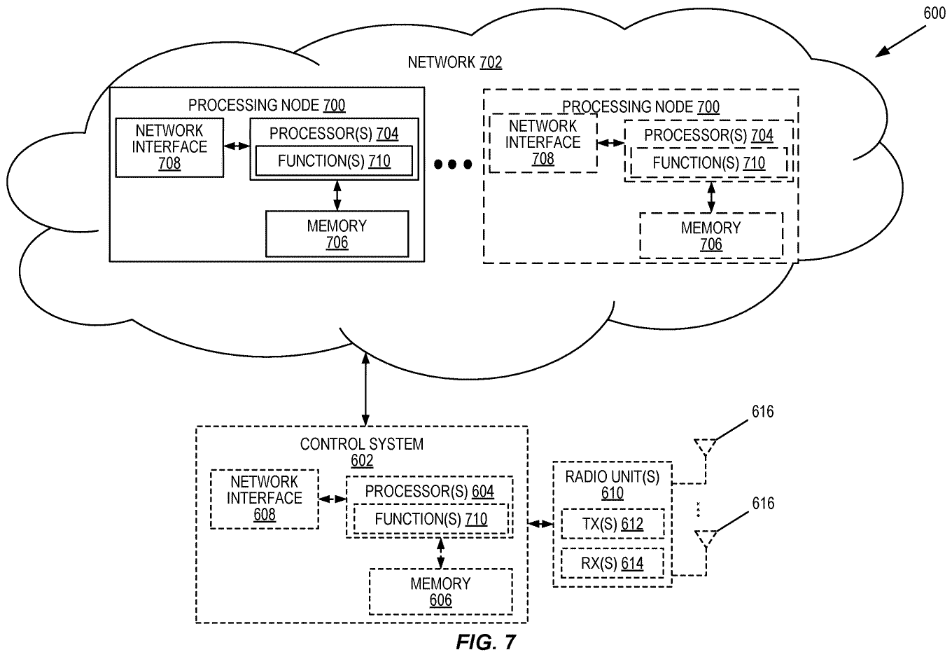

FIG. 7 is a schematic block diagram that illustrates a virtualized embodiment of the network node 600 according to some embodiments of the present disclosure. Again, optional features are represented by dashed boxes. As used herein, a “virtualized” network node is an implementation of the network node 600 in which at least a portion of the functionality of the network node 600 is implemented as a virtual component(s) (e.g., via a virtual machine(s) executing on a physical processing node(s) in a network(s)). As illustrated, in this example, if the network node 600 is a radio access node, the network node 600 may include the control system 602 and/or the one or more radio units 610, as described above. The control system 602 may be connected to the radio unit(s) 610 via, for example, an optical cable or the like. The network node 600 includes one or more processing nodes 700 coupled to or included as part of a network(s) 702. If present, the control system 602 or the radio unit(s) are connected to the processing node(s) 700 via the network 702. Each processing node 700 includes one or more processors 704 (e.g., CPUs, ASICs, FPGAs, and/or the like), memory 706, and a network interface 708.

In this example, functions 710 of the network node 600 described herein (e.g., one or more functions of a base station 202 described herein) are implemented at the one or more processing nodes 700 or distributed across the one or more processing nodes 700 and the control system 602 and/or the radio unit(s) 610 in any desired manner. In some particular embodiments, some or all of the functions 710 of the network node 600 described herein are implemented as virtual components executed by one or more virtual machines implemented in a virtual environment(s) hosted by the processing node(s) 700. As will be appreciated by one of ordinary skill in the art, additional signaling or communication between the processing node(s) 700 and the control system 602 is used in order to carry out at least some of the desired functions 710. Notably, in some embodiments, the control system 602 may not be included, in which case the radio unit(s) 610 communicate directly with the processing node(s) 700 via an appropriate network interface(s).

In some embodiments, a computer program including instructions which, when executed by at least one processor, causes the at least one processor to carry out the functionality of the network node 600 or a node (e.g., a processing node 700) implementing one or more of the functions 710 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the network node 600 according to some other embodiments of the present disclosure. The network node 600 includes one or more modules 800, each of which is implemented in software. The module(s) 800 provides the functionality of the network node 600 described herein. This discussion is equally applicable to the processing node 700 of FIG. 7 where the modules 800 may be implemented at one of the processing nodes 700 or distributed across multiple processing nodes 700 and/or distributed across the processing node(s) 700 and the control system 602.

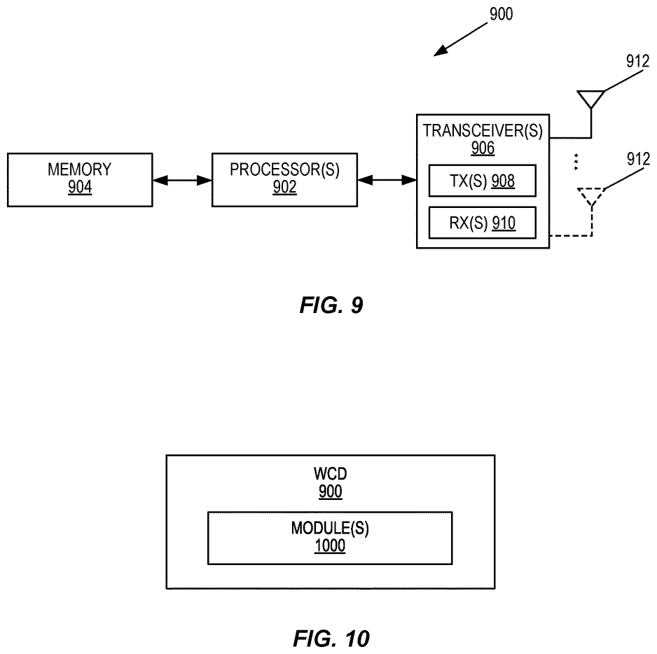

FIG. 9 is a schematic block diagram of a wireless communication device 900 (e.g., a UE) according to some embodiments of the present disclosure. As illustrated, the wireless communication device 900 includes one or more processors 902 (e.g., CPUs, ASICs, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by one of ordinary skill in the art. The processors 902 are also referred to herein as processing circuitry. The transceivers 906 are also referred to herein as radio circuitry. In some embodiments, the functionality of the wireless communication device 900 (or UE) described above may be fully or partially implemented in software that is, e.g., stored in the memory 904 and executed by the processor(s) 902. Note that the wireless communication device 212 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the wireless communication device 900 and/or allowing output of information from the wireless communication device 900), a power supply (e.g., a battery and associated power circuitry), etc.

In some embodiments, a computer program including instructions which, when executed by at least one processor, causes the at least one processor to carry out the functionality of the wireless communication device 900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the wireless communication device 900 according to some other embodiments of the present disclosure. The wireless communication device 900 includes one or more modules 1000, each of which is implemented in software. The module(s) 1000 provide the functionality of the wireless communication device 900 (or UE) described herein.

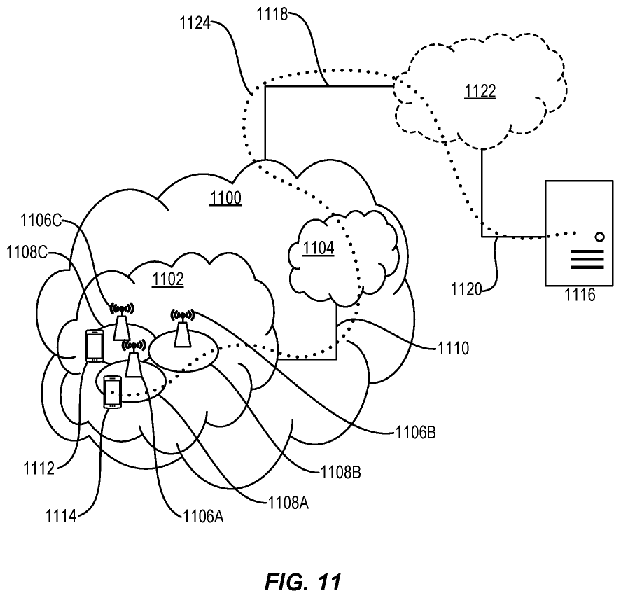

With reference to FIG. 11, in accordance with an embodiment, a communication system includes a telecommunication network 1100, such as a 3GPP-type cellular network, which comprises an access network 1102, such as a RAN, and a core network 1104. The access network 1102 comprises a plurality of base stations 1106A, 1106B, 1106C, such as Node Bs, eNBs, gNBs, or other types of wireless Access Points (APs), each defining a corresponding coverage area 1108A, 1108B, 1108C. Each base station 1106A, 1106B, 1106C is connectable to the core network 1104 over a wired or wireless connection 1110. A first UE 1112 located in coverage area 1108C is configured to wirelessly connect to, or be paged by, the corresponding base station 1106C. A second UE 1114 in coverage area 1108A is wirelessly connectable to the corresponding base station 1106A. While a plurality of UEs 1112, 1114 are illustrated in this example, the disclosed embodiments are equally applicable to a situation where a sole UE is in the coverage area or where a sole UE is connecting to the corresponding base station 1106.

The telecommunication network 1100 is itself connected to a host computer 1116, which may be embodied in the hardware and/or software of a standalone server, a cloud-implemented server, a distributed server, or as processing resources in a server farm. The host computer 1116 may be under the ownership or control of a service provider, or may be operated by the service provider or on behalf of the service provider. Connections 1118 and 1120 between the telecommunication network 1100 and the host computer 1116 may extend directly from the core network 1104 to the host computer 1116 or may go via an optional intermediate network 1122. The intermediate network 1122 may be one of, or a combination of more than one of, a public, private, or hosted network; the intermediate network 1122, if any, may be a backbone network or the Internet; in particular, the intermediate network 1122 may comprise two or more sub-networks (not shown).

The communication system of FIG. 11 as a whole enables connectivity between the connected UEs 1112, 1114 and the host computer 1116. The connectivity may be described as an Over-the-Top (OTT) connection 1124. The host computer 1116 and the connected UEs 1112, 1114 are configured to communicate data and/or signaling via the OTT connection 1124, using the access network 1102, the core network 1104, any intermediate network 1122, and possible further infrastructure (not shown) as intermediaries. The OTT connection 1124 may be transparent in the sense that the participating communication devices through which the OTT connection 1124 passes are unaware of routing of uplink and downlink communications. For example, the base station 1106 may not or need not be informed about the past routing of an incoming downlink communication with data originating from the host computer 1116 to be forwarded (e.g., handed over) to a connected UE 1112. Similarly, the base station 1106 need not be aware of the future routing of an outgoing uplink communication originating from the UE

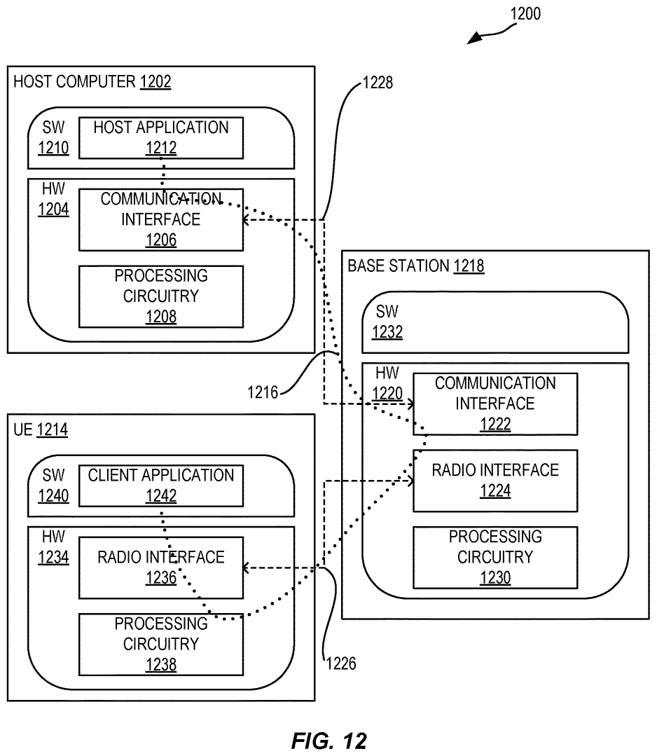

Example implementations, in accordance with an embodiment, of the UE, base station, and host computer discussed in the preceding paragraphs will now be described with reference to FIG. 12. In a communication system 1200, a host computer 1202 comprises hardware 1204 including a communication interface 1206 configured to set up and maintain a wired or wireless connection with an interface of a different communication device of the communication system 1200. The host computer 1202 further comprises processing circuitry 1208, which may have storage and/or processing capabilities. In particular, the processing circuitry 1208 may comprise one or more programmable processors, ASICs, FPGAs, or combinations of these (not shown) adapted to execute instructions. The host computer 1202 further comprises software 1210, which is stored in or accessible by the host computer 1202 and executable by the processing circuitry 1208. The software 1210 includes a host application 1212. The host application 1212 may be operable to provide a service to a remote user, such as a UE 1214 connecting via an OTT connection 1216 terminating at the UE 1214 and the host computer 1202. In providing the service to the remote user, the host application 1212 may provide user data which is transmitted using the OTT connection 1216.

The communication system 1200 further includes a base station 1218 provided in a telecommunication system and comprising hardware 1220 enabling it to communicate with the host computer 1202 and with the UE 1214. The hardware 1220 may include a communication interface 1222 for setting up and maintaining a wired or wireless connection with an interface of a different communication device of the communication system 1200, as well as a radio interface 1224 for setting up and maintaining at least a wireless connection 1226 with the UE 1214 located in a coverage area (not shown in FIG. 12) served by the base station 1218. The communication interface 1222 may be configured to facilitate a connection 1228 to the host computer 1202. The connection 1228 may be direct or it may pass through a core network (not shown in FIG. 12) of the telecommunication system and/or through one or more intermediate networks outside the telecommunication system. In the embodiment shown, the hardware 1220 of the base station 1218 further includes processing circuitry 1230, which may comprise one or more programmable processors, ASICs, FPGAs, or combinations of these (not shown) adapted to execute instructions. The base station 1218 further has software 1232 stored internally or accessible via an external connection.

The communication system 1200 further includes the UE 1214 already referred to. The UE's 1214 hardware 1234 may include a radio interface 1236 configured to set up and maintain a wireless connection 1226 with a base station serving a coverage area in which the UE 1214 is currently located. The hardware 1234 of the UE 1214 further includes processing circuitry 1238, which may comprise one or more programmable processors, ASICs, FPGAs, or combinations of these (not shown) adapted to execute instructions. The UE 1214 further comprises software 1240, which is stored in or accessible by the UE 1214 and executable by the processing circuitry 1238. The software 1240 includes a client application 1242. The client application 1242 may be operable to provide a service to a human or non-human user via the UE 1214, with the support of the host computer 1202. In the host computer 1202, the executing host application 1212 may communicate with the executing client application 1242 via the OTT connection 1216 terminating at the UE 1214 and the host computer 1202. In providing the service to the user, the client application 1242 may receive request data from the host application 1212 and provide user data in response to the request data. The OTT connection 1216 may transfer both the request data and the user data. The client application 1242 may interact with the user to generate the user data that it provides.

It is noted that the host computer 1202, the base station 1218, and the UE 1214 illustrated in FIG. 12 may be similar or identical to the host computer 1116, one of the base stations 1106A, 1106B, 1106C, and one of the UEs 1112, 1114 of FIG. 11, respectively. This is to say, the inner workings of these entities may be as shown in FIG. 12 and independently, the surrounding network topology may be that of FIG. 11.

In FIG. 12, the OTT connection 1216 has been drawn abstractly to illustrate the communication between the host computer 1202 and the UE 1214 via the base station 1218 without explicit reference to any intermediary devices and the precise routing of messages via these devices. The network infrastructure may determine the routing, which may be configured to hide from the UE 1214 or from the service provider operating the host computer 1202, or both. While the OTT connection 1216 is active, the network infrastructure may further take decisions by which it dynamically changes the routing (e.g., on the basis of load balancing consideration or reconfiguration of the network).

The wireless connection 1226 between the UE 1214 and the base station 1218 is in accordance with the teachings of the embodiments described throughout this disclosure. One or more of the various embodiments improve the performance of OTT services provided to the UE 1214 using the OTT connection 1216, in which the wireless connection 1226 forms the last segment.

A measurement procedure may be provided for the purpose of monitoring data rate, latency, and other factors on which the one or more embodiments improve. There may further be an optional network functionality for reconfiguring the OTT connection 1216 between the host computer 1202 and the UE 1214, in response to variations in the measurement results. The measurement procedure and/or the network functionality for reconfiguring the OTT connection 1216 may be implemented in the software 1210 and the hardware 1204 of the host computer 1202 or in the software 1240 and the hardware 1234 of the UE 1214, or both. In some embodiments, sensors (not shown) may be deployed in or in association with communication devices through which the OTT connection 1216 passes; the sensors may participate in the measurement procedure by supplying values of the monitored quantities exemplified above, or supplying values of other physical quantities from which the software 1210, 1240 may compute or estimate the monitored quantities. The reconfiguring of the OTT connection 1216 may include message format, retransmission settings, preferred routing, etc.; the reconfiguring need not affect the base station 1218, and it may be unknown or imperceptible to the base station 1218. Such procedures and functionalities may be known and practiced in the art. In certain embodiments, measurements may involve proprietary UE signaling facilitating the host computer 1202's measurements of throughput, propagation times, latency, and the like. The measurements may be implemented in that the software 1210 and 1240 causes messages to be transmitted, in particular empty or ‘dummy’ messages, using the OTT connection 1216 while it monitors propagation times, errors, etc.

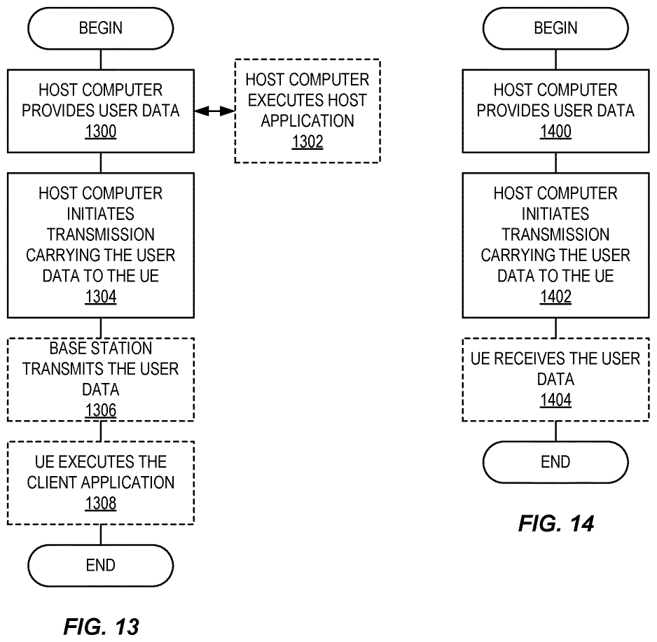

FIG. 13 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 13 will be included in this section. In step 1300, the host computer provides user data. In sub-step 1302 (which may be optional) of step 1300, the host computer provides the user data by executing a host application. In step 1304, the host computer initiates a transmission carrying the user data to the UE. In step 1306 (which may be optional), the base station transmits to the UE the user data which was carried in the transmission that the host computer initiated, in accordance with the teachings of the embodiments described throughout this disclosure. In step 1308 (which may also be optional), the UE executes a client application associated with the host application executed by the host computer.

FIG. 14 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 14 will be included in this section. In step 1400 of the method, the host computer provides user data. In an optional sub-step (not shown) the host computer provides the user data by executing a host application. In step 1402, the host computer initiates a transmission carrying the user data to the UE. The transmission may pass via the base station, in accordance with the teachings of the embodiments described throughout this disclosure. In step 1404 (which may be optional), the UE receives the user data carried in the transmission.

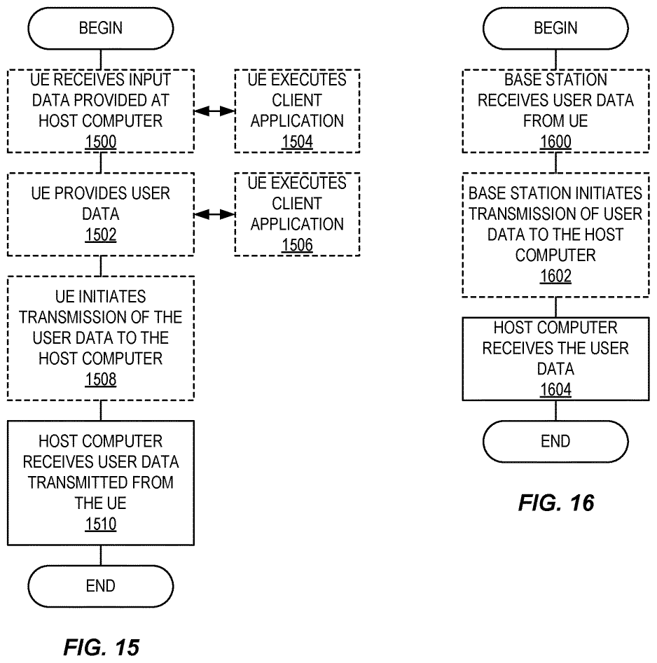

FIG. 15 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 15 will be included in this section. In step 1500 (which may be optional), the UE receives input data provided by the host computer. Additionally or alternatively, in step 1502, the UE provides user data. In sub-step 1504 (which may be optional) of step 1500, the UE provides the user data by executing a client application. In sub-step 1506 (which may be optional) of step 1502, the UE executes a client application which provides the user data in reaction to the received input data provided by the host computer. In providing the user data, the executed client application may further consider user input received from the user. Regardless of the specific manner in which the user data was provided, the UE initiates, in sub-step 1508 (which may be optional), transmission of the user data to the host computer. In step 1510 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 16 will be included in this section. In step 1600 (which may be optional), in accordance with the teachings of the embodiments described throughout this disclosure, the base station receives user data from the UE. In step 1602 (which may be optional), the base station initiates transmission of the received user data to the host computer. In step 1604 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a network node, the method comprising: determining (400) a geographic area of interest for sensing objects near a moving vehicle equipped with a User Equipment, UE, based on a geographic location of the UE and a velocity vector of the UE; selecting (402) a set of sensing beams for sensing objects near the moving vehicle equipped with the UE based on the geographic area of interest and a beam direction of a beam used by the network node to transmit downlink information to the UE; and performing (404) a sensing procedure for passively sensing objects near the moving vehicle using the set of sensing beams.

Embodiment 2: The method of embodiment 1 wherein the steps of determining (400), selecting (402), and performing (404) are performed by the network node simultaneously with a separate procedure for determining the beam used by the network node to transmit downlink information to the UE.

Embodiment 3: The method of embodiment 2 wherein the steps of determining (400), selecting (402), and performing (404) are performed by the network node on a first frequency or frequency range and the separate procedure for determining the beam used by the network node to transmit downlink information to the UE is performed on a second frequency or frequency range that is different than the first frequency or frequency range.

Embodiment 4: The method of any of embodiments 1 to 3 wherein the network node is a base station of a cellular communications system.

Embodiment 5: A method performed by a network node, the method comprising one or more of the following: performing (500A-510A) a beam selection procedure for selection of a transmit beam to use for downlink communication to a User Equipment, UE; selecting (520A) a set of sensing beams for sensing objects near the UE; transmitting (520A) sensing signals on the set of sensing beams; adapting (530A) one or more beams used for the beam selection procedure for the transmit beam to use for downlink communication to the UE based on results of transmitting (520A) the sensing signals on the set of sensing beams.

Embodiment 6: The method of embodiment 5 wherein performing (500A-510A) the beam selection procedure comprises: transmitting a first set of beams; receiving feedback information from a User Equipment, UE, for at least one of the first set of beams; transmitting a second set of beams in a direction of the at least one of the first set of beams, wherein each beam in the second set of beams is narrower than each of beam in the first set of beams; receiving feedback information from the UE for at least one of the second set of beams; and selecting a transmit beam to use for downlink communication with the UE based on the feedback information from the UE for the at least one of the second set of beams.

Embodiment 7: The method of embodiment 6 wherein the first set of beams is a set of communication beams (e.g., a set of SSB and/or CSI-RS beams).

Embodiment 8: The method of embodiment 6 or 7 wherein the second set of beams is a set of positioning beams (e.g., a set of PRS beams).

Embodiment 9: The method of any of embodiments 6 to 8 wherein adapting (530A) one or more beams used for the beam selection procedure comprises adapting (530A) one or more of the first set of beams and/or one or more of the second set of beams, based on results of transmitting (520A) the sensing signals on the set of sensing beams.

Embodiment 10: The method of any of embodiments 5 to 9 wherein the results of the transmitting (520A) the sensing signals on the set of sensing beams comprises determining that an object is sensed for one of the set of sensing beams, and adapting (530A) one or more beams used for the beam selection procedure comprises adapting (530A) one or more parameters for one or more beams used for the beam selection procedure based on the one of the set of sensing beams for which an object is sensed.

Embodiment 11: The method of embodiment 10 wherein adapting (530A) the one or more parameters for the one or more beams used for the beam selection procedure comprises adapting (530A) the one or more parameters for the one or more beams used for the beam selection procedure based on a Quasi Co-Located, QCL, relationship defined between the one of the set of sensing beams and one or more of the first and/or second set(s) of beams.

Embodiment 12: The method of embodiment 10 or 11 wherein the one or more parameters that are adapted comprise one or more spatial Tx parameters.

Embodiment 13: The method of any of embodiments 5 to 9 wherein the results of the transmitting (520A) the sensing signals on the set of sensing beams comprises determining that an object is sensed for one of the set of sensing beams, and adapting the one or more parameters comprises adapting either or both of: one or more angular offsets for the one or more beams used for the beam selection procedure relative to the one of the set of sensing beams for which the object is detected; and a transmission reference point used for transmitting the sensing beams (e.g., which positioning beams is used as a reference point for transmitting the sensing beams).

Embodiment 14: The method of any of embodiments 5 to 13 wherein selecting (520A) the set of sensing beams comprises selecting (520A) the set of sensing beams based on a geographic area of interest for sensing, the geographic area of interest for sensing being based on a current geographic location of the UE and a velocity of the UE.

Embodiment 15: The method of any of embodiments 5 to 14 wherein the UE is a UE with which a moving vehicle is equipped.

Embodiment 16: The method of any of the previous embodiments, further comprising: obtaining user data; and forwarding the user data to a host computer or a wireless device.

### Group B Embodiments

Embodiment 17: A base station comprising:
processing circuitry configured to perform any of the steps of any of the Group A embodiments; and
power supply circuitry configured to supply power to the base station.

Embodiment 18: A communication system including a host computer comprising:
processing circuitry configured to provide user data; and
a communication interface configured to forward the user data to a cellular network for transmission to a User Equipment, UE;
wherein the cellular network comprises a base station having a radio interface and processing circuitry, the base station's processing circuitry configured to perform any of the steps of any of the Group A embodiments.

Embodiment 19: The communication system of the previous embodiment further including the base station.

Embodiment 20: The communication system of the previous 2 embodiments, further including the UE, wherein the UE is configured to communicate with the base station.

Embodiment 21: The communication system of the previous 3 embodiments, wherein:
the processing circuitry of the host computer is configured to execute a host application, thereby providing the user data; and
the UE comprises processing circuitry configured to execute a client application associated with the host application.

Embodiment 22: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the base station performs any of the steps of any of the Group A embodiments.

Embodiment 23: The method of the previous embodiment, further comprising, at the base station, transmitting the user data.

Embodiment 24: The method of the previous 2 embodiments, wherein the user data is provided at the host computer by executing a host application, the method further comprising, at the UE, executing a client application associated with the host application.

Embodiment 25: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group A embodiments.

Embodiment 26: The communication system of the previous embodiment further including the base station.

Embodiment 27: The communication system of the previous 2 embodiments, further including the UE, wherein the UE is configured to communicate with the base station.

Embodiment 28: The communication system of the previous 3 embodiments, wherein:
the processing circuitry of the host computer is configured to execute a host application; and
the UE is configured to execute a client application associated with the host application, thereby providing the user data to be received by the host computer.

Those skilled in the art will recognize improvements and modifications to the embodiments of the present disclosure. All such improvements and modifications are considered within the scope of the concepts disclosed herein.

1. A method performed by a network node for a wireless communication system, the method comprising:
determining a geographic area of interest for sensing objects relevant to a moving vehicle equipped with a User Equipment (UE) based on a geographic location of the UE and a velocity vector of the UE;
selecting a set of sensing beams for sensing objects relevant to the moving vehicle equipped with the UE based on the geographic area of interest and a beam direction of a beam used by the network node to transmit downlink information to the UE; and
performing a sensing procedure for passively sensing objects relevant to the moving vehicle using the set of sensing beams.

2. The method of claim 1, wherein the steps of determining, selecting, and performing are performed by the network node simultaneously with a separate procedure for determining the beam used by the network node to transmit downlink information to the UE.

3. The method of claim 2, wherein the steps of determining, selecting, and performing are performed by the network node on a first frequency or frequency range and the separate procedure for determining the beam used by the network node to transmit downlink information to the UE is performed on a second frequency or frequency range that is different than the first frequency or frequency range.

4. The method of claim 1, wherein the beam direction of the beam used by the network node to transmit downlink information to the UE comprises an angle of departure of the beam used by the network node to transmit downlink information to the UE.

5. The method of claim 1, wherein the geographic area of interest for sensing objects relevant to the moving vehicle equipped with the UE is a geographic area that includes the geographic location of the UE and an geographic area ahead of the geographic location of the UE as determined by the velocity vector of the UE.

6. The method of claim 1, wherein the velocity vector of the UE comprises a speed of movement of the UE and a direction of movement of the UE, and a size of the geographic area of interest for sensing objects relevant to the moving vehicle equipped with the UE is based on the speed of movement of the UE.

7. The method of claim 1, wherein the set of sensing beams for sensing objects relevant to the moving vehicle equipped with the UE consists of one or more beams directed to the determined geographic area of interest for sensing objects relevant to the moving vehicle equipped with the UE.

8. The method of claim 1, wherein the set of sensing beams for sensing objects relevant to the moving vehicle equipped with the UE comprises the beam used by the network node to transmit downlink information to the UE.

9. The method of claim 1, wherein selecting the set of sensing beams comprises selecting the set of sensing beams such that the set of sensing beams consists of one or more beams that: (a) are directed to the determined geographic area of interest for sensing objects relevant to the moving vehicle equipped with the UE and (b) have a transmit power that is based on a transmit power of the beam used by the network node to transmit downlink information to the UE.

10. The method of claim 1, wherein the velocity vector of the UE comprises a speed of movement of the UE and a direction of movement of the UE, and selecting the set of sensing beams comprises selecting the set of sensing beams such that a beam granularity of the set of sensing beams is based on the speed of movement of the UE.

11. The method of claim 1, wherein the network node is a base station of a cellular communications system.

12. The method of claim 1, wherein the downlink information is downlink information carried by a Physical Downlink Shared Channel (PDSCH) to the UE.

13. The method of claim 11, wherein one or more Quasi Co-Located (QCL) parameters are defined for the beam used by the network node to transmit downlink information to the UE and the set of sensing beams.

14. The method of claim 11, wherein one or more Quasi Co-Located (QCL) parameters are defined for a positioning reference signal beam and the set of sensing beams.

15. The method of claim 11, wherein a Quasi Co-Located (QCL) parameter determined for the beam used by the network node to transmit downlink information to the UE is used by the network node to select one or more parameters for one or more sensing beams, from among the set of sensing beams, for which there is a QCL relationship, wherein the one or more parameters for the one or more sensing beams comprise any one or more of the following parameters: beam direction, transmit power. precoder matrix, codebook, beam granularity in space, beam granularity in time, and beam granularity in frequency.

16-18. (canceled)

19. A network node for a wireless communication system, the network node comprising processing circuitry configured to cause the network node to:
determine a geographic area of interest for sensing objects relevant to a moving vehicle equipped with a User Equipment (UE) based on a geographic location of the UE and a velocity vector of the UE;
select a set of sensing beams for sensing objects relevant to the moving vehicle equipped with the UE based on the geographic area of interest and a beam direction of a beam used by the network node to transmit downlink information to the UE; and
perform a sensing procedure for passively sensing objects relevant to the moving vehicle using the set of sensing beams.

20-37. (canceled)
